(19) United States
(12) Patent Application Publication
(10) Pub. No.: US 2023/0060255 A1
(43) Pub. Date: Mar. 2, 2023

(54) PRESSURE GAUGE WITH DIVISIONAL SCALE

(71) Applicant: BETO ENGINEERING AND MARKETING CO., LTD., TAICHUNG CITY (TW)

(72) Inventor: Lopin WANG, TAICHUNG CITY (TW)

(21) Appl. No.: 17/522,415

(22) Filed: Nov. 9, 2021

(30) Foreign Application Priority Data
Aug. 30, 2021 (TW) 110132030

(51) Int. Cl. G01L 7/04

(52) U.S. Cl. CPC G01L 7/043

(57) ABSTRACT

A pressure gauge with divisional scale includes a piston tube, a piston, an elastic member, a rotating member and a pointer connected with the rotating member. The piston has plural transmission portions and is slidably disposed in the piston tube. The elastic member is disposed inside the piston tube and abutted against the piston. The rotating member has plural gears sequentially and respectively engaged with the transmission portions when the piston slides so as to drive the pointer to swivel, thereby achieving a pressure gauge with a single pointer indicating multiple pressure ranges.

### BACKGROUND OF THE INVENTION

### 1. Field of the Invention

The present invention relates to measuring appliances, especially a pressure gauge with divisional scale.

### 2. Description of the Related Art

For various occasions where gas pressure needs to be measured, such as in a task of confirming the tire pressure of the vehicle, the internal pressure of the pneumatic shock absorber, or the high-pressure gas pressure of industrial equipment or manufacturing process, pressure gauge is usually used for observation and identification of pressure.

For example, the commercially-available, general-purpose bicycle pumps commonly used on the market are mostly equipped with a pressure gauge with a scale to display the pressure of the inflated tire. The scale of pressure gauge is generally arranged in units of 5 psi or 10 psi in equidistant intervals; however, the aforesaid scale arrangement often causes a lot of trouble for professional cyclists when they need to more accurately interpret the value of the low-pressure zone. In practice, the tire pressure of bicycle tires shall be adjusted according to the route, road conditions, and tire types. Therefore, the tire pressure will be adjusted according to environmental requirements during the riding. If a pressure gauge with only a single scale of the same interval is used, it often results in that the pressure cannot be accurately interpreted in a certain interval, so that it is impossible to accurately determine how much tire pressure needs to be increased or decreased when the air is pumped or flattened.

At present, relevant technologies have tried to solve the above problems. For example, TWI336396 patent discloses a pressure gauge that can display different pressure values on both sides. It mainly uses the Bourdon tube pressure measuring mechanism to link the reduction gear to drive the pointers of two dials with different pressure ranges. Through the surface scale ranges of different dials, the operator can selectively identify the indicating scale and judge the pressure value.

Another example is the pressure gauge disclosed in the TWI647433 patent, which includes a body, a first dial, a second dial, a reduction gear, and a pressure sensor set. The body is adapted for being connected to a pressure source. The first dial is set on one side of the body and includes a first pointer and a first scale. The second dial is set on the other side of the body and includes a second pointer and a second scale different from the first scale. The reduction gear is installed in a chamber and can link the first pointer and the second pointer. The pressure sensor set is arranged in the chamber and includes a plug member and an elastic member for biasing the plug member. The plug member can be pushed by the pressure medium to compress the elastic member, and the plug member is linked with the reduction gear to drive the first pointer and the second pointer to swivel, so as to display different pressure scales for facilitating interpretation.

In short, the structures of the above-mentioned existing pressure gauges are relatively complicated to cause high manufacturing cost, and the use of the two dials is extremely inconvenient, resulting in difficulty in interpreting and poor accuracy in indicating the pressure values.

### SUMMARY OF THE INVENTION

The present invention has been accomplished in view of the above-noted circumstances. It is an objective of the present invention to provide a pressure gauge with divisional scale, which utilizes a single pointer to indicate a plurality of different pressure interval scales, has a simple structure with reduced manufacturing cost, and is easier and more accurate to interpret pressure values.

To achieve the above-mentioned objective, the present invention provides a pressure gauge with divisional scale comprising a piston tube, a piston, an elastic member, a rotating member and a pointer. The piston has a plurality of transmission portions and is slidably disposed in the piston tube. The elastic member is disposed inside the piston tube and configured to exert an elastic force against the piston. The rotating member has a plurality of gears. The pointer is driven by the rotating member to swivel. The rotating member is configured in a way that when the piston slides in the piston tube, the gears are sequentially and respectively engaged with the transmission portions of the piston such that the pointer is driven by the rotating member to swivel, thereby achieving a pressure gauge with a single pointer indicating a plurality of pressure ranges. With the aforesaid technical features, the structure of the pressure gauge of the present invention is simple, the manufacturing cost is reduced, and the pressure gauge is easier and more accurate to interpret the pressure values.

Preferably, the piston may comprise an extension arm that protrudes from one end of the piston and extends in an axial direction. The transmission portions are arranged at intervals or dislocations along the extension arm.

Preferably, the transmission portions may be formed on an outer circumference of the piston.

Preferably, the rotating member may comprise a central shaft, on which the gears are coaxially formed with different diameters.

Preferably, the pressure gauge may further comprise a dial. The dial comprises a plurality of pressure indicating areas with divisional scale. The pointer is driven by the rotating member to swivel between the pressure indicating areas with different angle amplitudes.

In another aspect, the present invention also provides a pressure gauge with divisional scale, which comprises a piston having at least two transmission portions arranged at intervals, a rotating member having at least two gears sequentially and respectively engaged with the at least two transmission portions of the piston when the piston slides, such that the rotating member is rotatably driven by the piston, and a pointer driven by the rotating member to swivel.

Preferably, the piston may comprise an extension arm that protrudes from one end of the piston and extends in an axial direction. The at least two transmission portions are arranged at intervals along the extension arm.

Preferably, the rotating member may comprise a central shaft, on which the at least two gears are coaxially formed with different diameters.

Preferably, the pressure gauge may further comprise a dial. The dial comprises at least two pressure indicating areas with divisional scale. The pointer is driven by the rotating member to swivel between the at least two pressure indicating areas with different angle amplitudes.

In still another aspect, the invention also provides a pressure gauge with divisional scale, which comprises a piston comprising at least two transmission portions, a rotating member comprising at least two gears with different diameters and being rotated by the piston in a way that the at least two gears are sequentially and respectively engaged with the at least two transmission portions of the piston, and a pointer driven by said rotating member to swivel with at least two different angle amplitudes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is an exploded perspective view of a first preferred embodiment of the present invention.

FIG. 2 is a top view of the first preferred embodiment of the present invention.

FIG. 3 is a front view of the first preferred embodiment of the present invention.

FIG. 4 is a right-side view of the first preferred embodiment of the present invention.

FIG. 5 is a sectional view taken along line 5-5 of FIG. 3.

FIG. 6 is similar to FIG. 3, but showing a second gear is engaged with a second transmission portion.

FIG. 7 is a sectional view taken along line 7-7 of FIG. 6.

FIG. 8 is an exploded perspective view of a second preferred embodiment of the present invention.

FIG. 9 is a front view of the second preferred embodiment of the present invention.

FIG. 10 is a right side view of the second preferred embodiment of the present invention.

FIG. 11 is a sectional view taken along line 11-11 of FIG. 9.

FIG. 12 is similar to FIG. 9, but showing a third gear is engaged with a third transmission portion.

FIG. 13 is a sectional view taken along line 13-13 of FIG. 12.

FIG. 14 is similar to FIG. 1, but showing another embodiment of the present invention.

### DETAILED DESCRIPTION OF THE INVENTION

Hereinafter, the technical content and features of the present invention will be described in detail by the given preferred embodiments in conjunction with the drawings. The present invention can be widely used in various occasions where the pressure needs to be measured and is particularly suitable for the purpose of indicating different gas pressure ranges with a single pointer.

In the entire specification including the preferred embodiments described below and the claims of the patent application, the terms related to the directionality are based on the directions in the drawings, and the same reference numerals represent the same or similar elements or their technical characteristics. Those with ordinary skill in the art can understand that the explanatory terms of these preferred embodiments belong to generic terms that do not limit the application field. For example, technical terms such as structural and mechanical elements include, but not limited to, the technology specified in the description. The term “one” or “at least one” of the number of elements includes one and more than one element number, and the exemplary illustration recited in respective embodiment is not intended to limit the scope of claims.

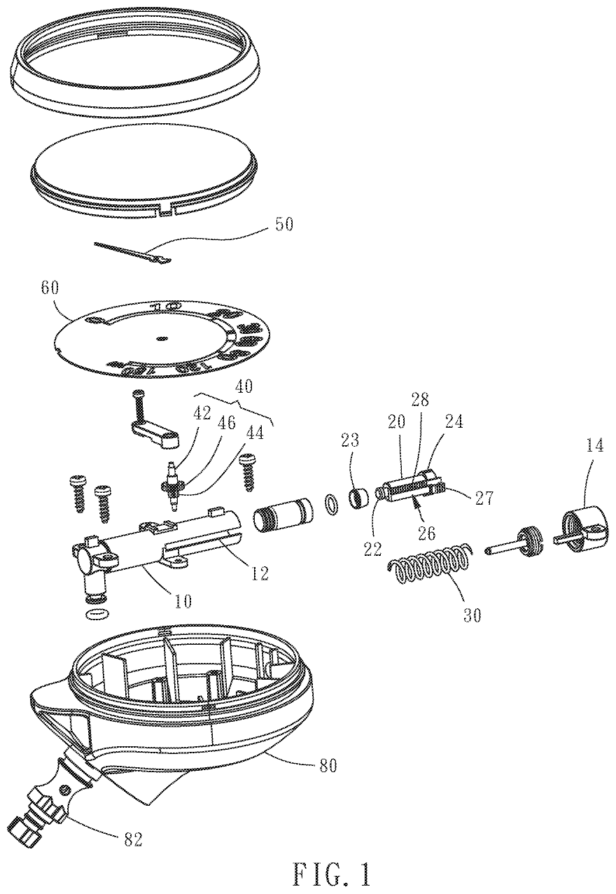

As shown in FIG. 1, the pressure gauge with divisional scale provided by a first preferred embodiment of the present invention is adapted to be arranged inside a housing 80 having an air inlet 82 that can be connected to an inflatable object to measure the pressure. Alternatively, the pressure gage can be installed with a pump to measure the pressure of the object to be inflated.

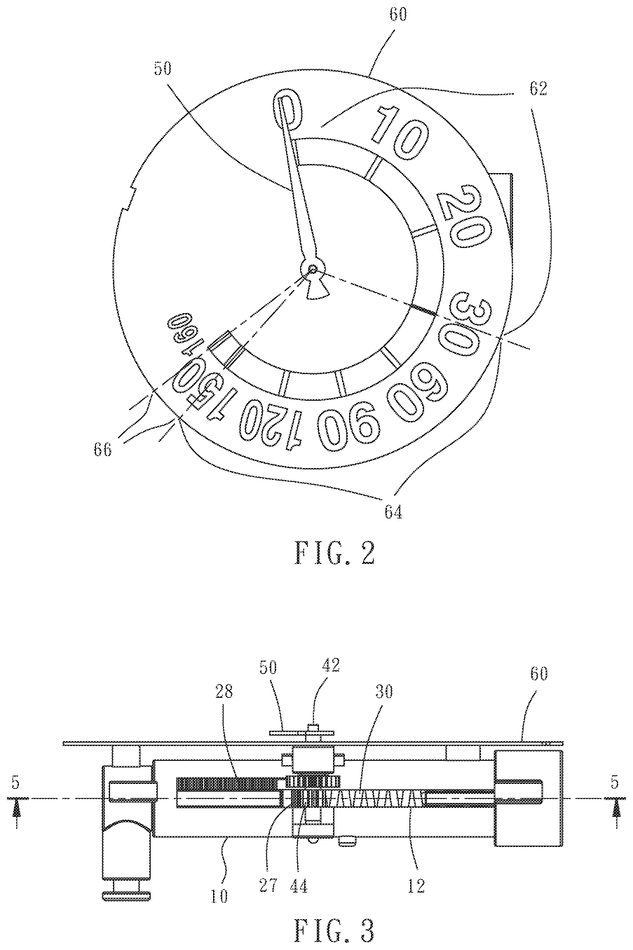

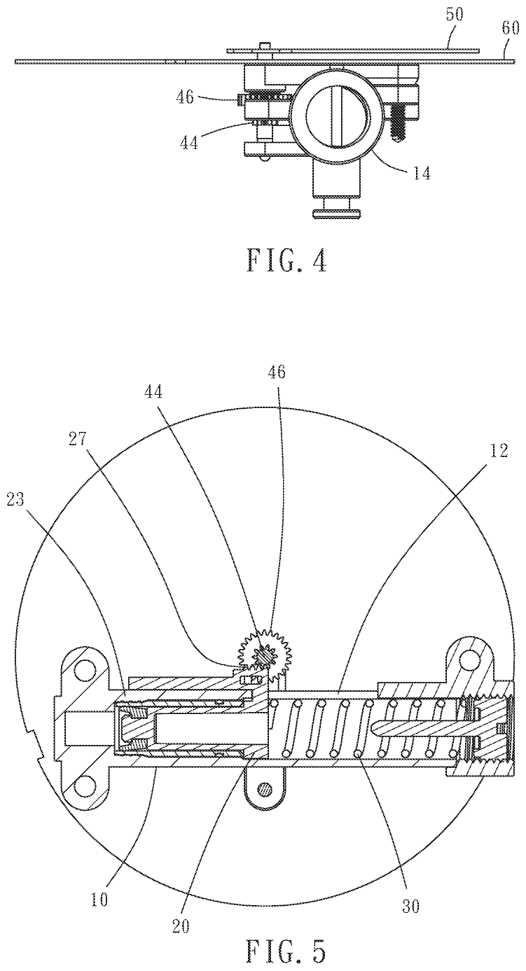

As shown in FIGS. 1 to 4, the pressure gauge comprises a piston tube 10, a piston 20, an elastic member 30, a rotating member 40, and a pointer 50. In this first preferred embodiment, the outer wall of the piston tube 10 has an opening 12 extending in the axial direction and communicating with the internal space of the piston tube 10. One end of the piston tube 10 is connected to the air inlet 82 of the housing 80 in an air communication manner, and the other end is capped with a cover 14. Both the piston 20 and the elastic member 30 are disposed inside the piston tube 10. The piston 20 has a first end 22 and a second end 24. The first end 22 of the piston 20 is provided with a seal 23, which is airtightly abutted against the inner wall of the piston tube 10 and faces the air inlet 82. and the second end 24 of the piston 20 abuts against one end of the elastic member 30. The other end of elastic member 30 is abutted against the cover 14. In this first preferred embodiment, the elastic member 30 is exemplarily realized, but not limited to, as a compression spring, which exerts an elastic force on the piston 20 toward the direction of the air inlet 82.

In this first preferred embodiment, the piston 20 comprises an extension arm 26 that protrudes outwardly from the second end 24 and extends axially toward the first end 22, and the extension arm 26 is provided with at least two transmission portions, namely first transmission portion 27 and second transmission portion 28 as example. The transmission portions of piston 20 can be realized as racks with different specifications in teeth number, teeth width, modulus, pressure angle, etc. The aforesaid factors of specification of racks can be selectively modified according to the design requirements. The piston 20 slidably moves inside the piston tube 10 upon receiving the air pressure from the air inlet 82 in a way that the extension arm 26 extends out of the piston tube 10 via the opening 12. As such, the first transmission portion 7 and the second transmission portion 28 are located outside the piston tube 10 and are sequentially spaced along a straight path or arranged in a dislocation manner at different axial and circumferential locations, such that the first and second transmission portions 27 and 28 move synchronously with the piston 20. In this preferred embodiment, the first transmission portion 27 and the second transmission portion 28 are arranged on the extension arm 26 in a non-overlapping manner.

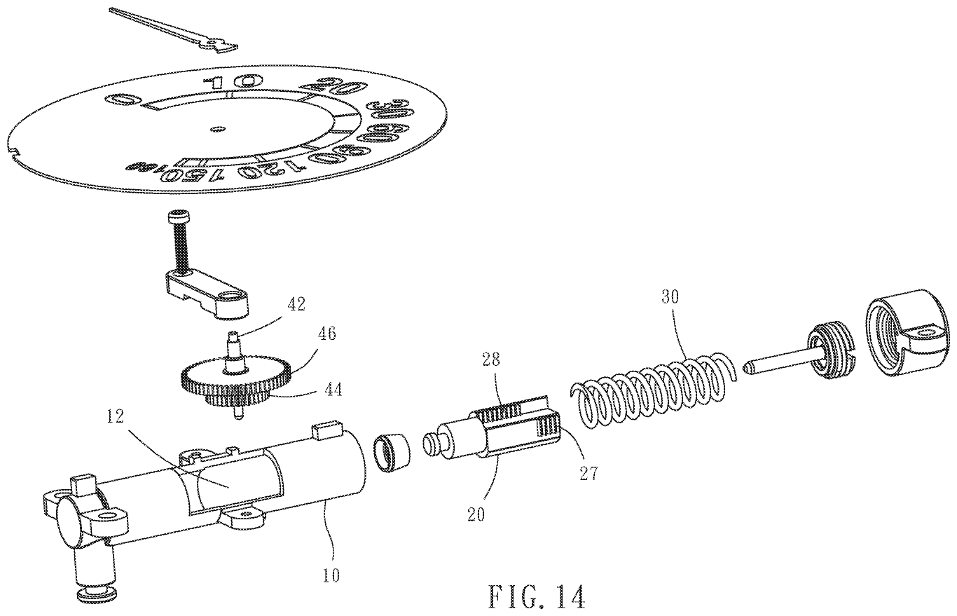

In another preferred embodiment, as shown in FIG. 14, the first transmission portion 27 and the second transmission portion 28 are directly integrally formed or arranged on the outer circumference of the piston 20 in a dislocation manner, i.e., the first and second transmission portions 27 and 28 are located at different axial and circumferential locations. When the piston 20 slides in the piston tube 10, the first transmission portion 27 and the second transmission portion 28 of the piston 20 protrude through the opening 12 to be selectively engaged with the rotating member 40, respectively.

The rotating member 40 comprises a central shaft 42. At least two gears with different diameters and coaxial with the central shaft 42 are formed on the outer periphery of the central shaft 42, In this preferred embodiment, a first gear 44 and a second gear 46 are exemplarily used for illustration, and the diameter of the first gear 44 is smaller than the diameter of the second gear 46 as an example. The central shaft 42 is arranged upright on the piston tube 10 adjacent to the opening 12, and the top of the central shaft 42 is fixedly connected with the pointer 50, such that the pointer 50 is drivenable by the rotating member 40 to swivel within a predetermined angle range. In addition, the central shaft 42 upwardly extends through a dial 60 stationarily mounted to the housing 80. The dial 60 has at least two pressure indicating areas. In this first preferred embodiment, the pressure indicating areas includes, but not limited to, a first pressure indicating area 62 in the low-pressure area ranging from 0 psi to 60 psi, and a second pressure indicating area 64 in the high-pressure area ranging from 60 psi to 160 psi. The scale intervals of the first pressure indicating area 62 and the second pressure indicating area 64 are different from each other in a way that the first pressure indicating area has a scale interval of 10 psi, and the second pressure indicating area has a scale interval of 30 psi. The pointer 50 is located above the dial 60. When the pointer 50 swivels along with rotational motion of the rotating member 40, the pressure value can be indicated through the first pressure indicating area 62 and second pressure indicating area 64 of the dial 60.

When the gas is introduced into the piston tube 10 through the air inlet 82 of the housing 80, the piston 20 in the piston tube 10 is pushed by the gas of different pressures of low and high, such that the first transmission portion 27 or the second transmission portion 28 of the extension arm 26 is respectively engaged the first gear 44 or the second gear 46 to drive the rotating member 40 to rotate.

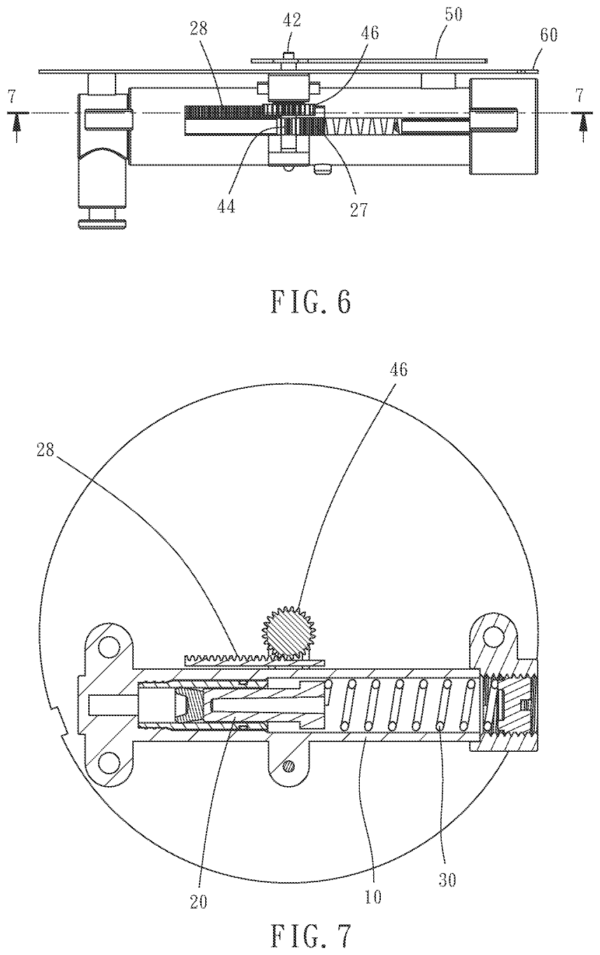

As shown in FIG. 3 to FIG. 5, when the piston 20 is pushed by the low pressure gas to move from the initial position, the first gear 44 with a smaller diameter is meshed with and driven by the first transmission portion 27, which slidably moves along a linear moving path. to rotate with a larger angle amplitude per pressure unit, which in turn drives the pointer 50 to swivel faster in the first pressure indicating area 62. The scale interval of the first pressure indicating area 62 is more obvious, which is easy to observe and interpret. As shown in FIG. 6 to FIG. 7, when the piston 20 is pushed by the high-pressure gas, the first gear 44 will be first meshed with and then disengaged from the first transmission portion 27, and then sequentially the second gear 46 with a larger diameter will be meshed with and driven by the second transmission portion 28, which continuously slidably moves along the same linear moving path, to rotate with a smaller angle amplitude per pressure unit, which in turn drives the pointer 50 to swivel more slowly in the second pressure indicating area 64. In other words, because the gear ratio of the first gear 44 to the first transmission portion 27 and the gear ratio of the second gear 46 to the second transmission portion 28 are different from each other, the pointer 50 will be driven by the rotating member 40 to swivel in the first and second pressure indicating areas 62 and 64 with two different angle amplitudes under a same pressure.

With the above structural features, the present invention can use the transmission portions at different positions to drive the gears of different diameters to swivel the pointer when the piston moves. The diameters of different gears and the different positions of the transmission portions allow the pointer to swivel in different angle amplitudes corresponding to the gas pressure, achieving the effect of using a single pointer and a single dial to indicate high and low gas pressures at the same time. As a result, the pressure gauge of the present invention can achieve the objective of simple structure, reduced manufacturing cost, and easier and more accurate pressure value interpretation.

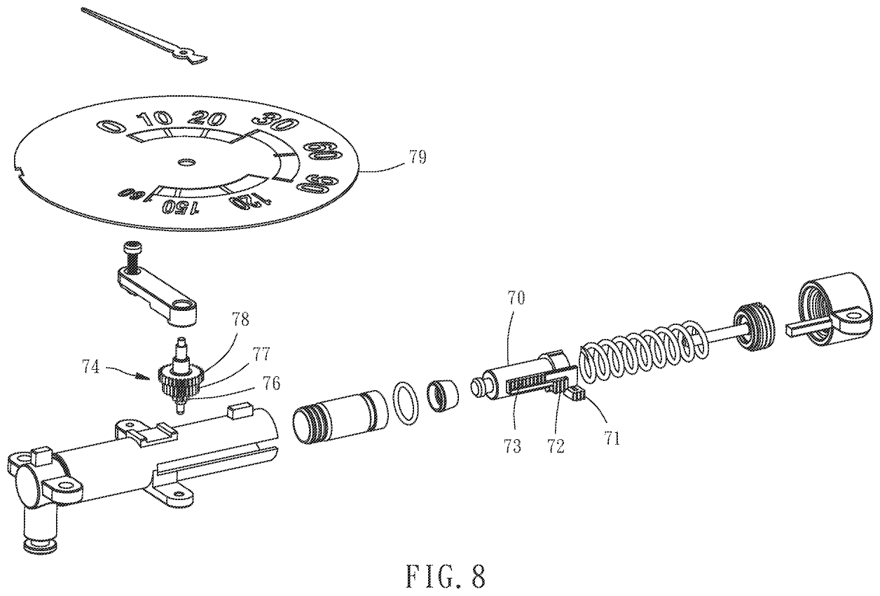

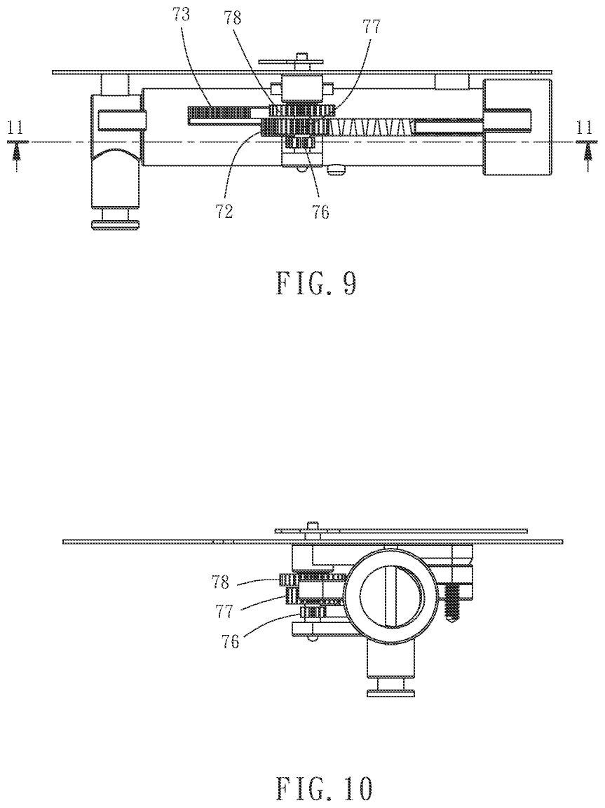

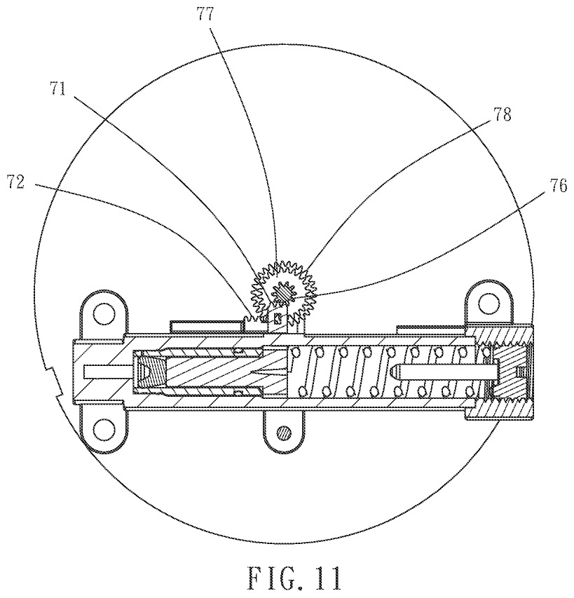

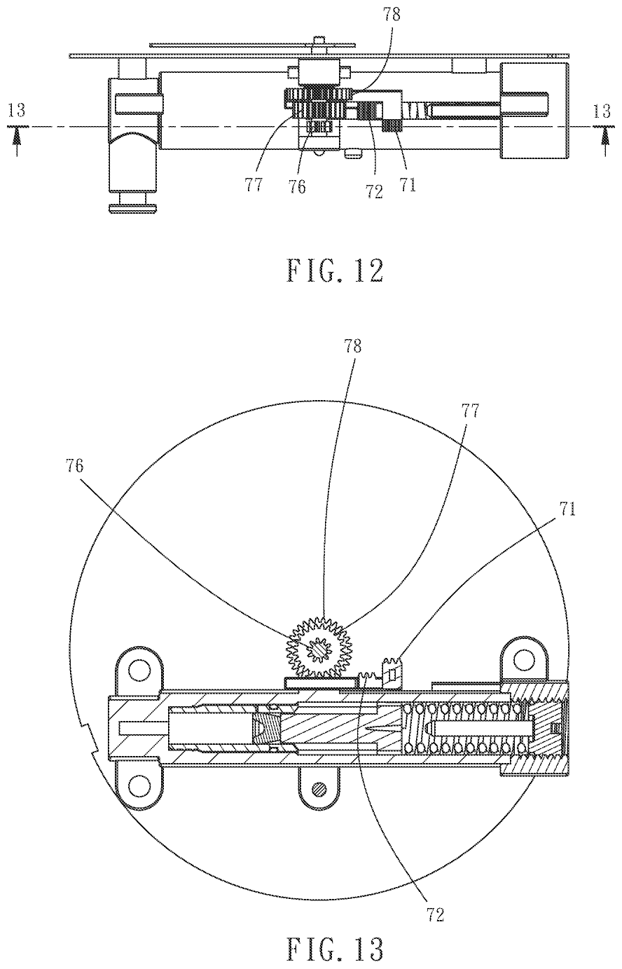

Under the same inventive concept of the foregoing first preferred embodiment of the present invention, two or more different pressure indicating areas may be added for easier interpretation. For example, FIGS. 8 to 13 show a pressure gauge with divisional scale in accordance with a second preferred embodiment of the present invention. This second preferred embodiment is substantially similar to the aforesaid first preferred embodiment with the differences as follows. The piston 70 comprises a first transmission portion 71, a second transmission portion 72, and a third transmission portion 73. In association with the piston 70, the rotating member 74 comprises a first gear 76, a second gear 77, and a third gear 78. The first gear 76 has the smallest diameter, the third gear 78 has the lamest diameter, and the second gear 77 has a diameter between the diameters of the first gear 76 and the second gear 77. The dial 79 has three pressure indicating areas with different scale intervals.

As shown in FIG. 9 and FIG. 13, when the piston 70 is moved from the initial position by a low-pressure gas, the first gear 76 with the smallest diameter is meshed with and driven by the first transmission portion 71, which slidably moves along a linear moving path, to rotate with a larger angle amplitude, such that the pointer 50 is driven to swivel quickly in the first pressure indicating area 62. When the piston 70 is pushed by a higher-pressure gas, the first gear 76 will be first meshed with and then disengaged from the first transmission portion 71, and then sequentially the second gear 77 with a larger diameter will be meshed with and driven by the second transmission portion 72 to rotate with a slightly smaller angle amplitude, such that the pointer 50 is driven to swivel in the second pressure indicating area 64 in a slightly slow manner. When the piston 70 is pushed by the highest-pressure gas, after the first and second gears 76 and 77 are disengaged from the first and second transmission portion 71 and 72 respectively, the third gear 78 with the largest diameter will be meshed with and driven by the third transmission portion 73 to rotate in a smaller angle amplitude, such that the pointer 50 is driven to swivel in a slower manner in the third pressure indicating area 66. In other words, using multiple sets of gears of different specifications and associated transmission portions can also achieve the above-mentioned objective and technical advantages of the present invention.

What is claimed is:

1. A pressure gauge with divisional scale, comprising:
a piston tube;
a piston comprising at least two transmission portions, said piston being slidably disposed in said piston tube;
an elastic member disposed inside said piston tube in a way that said elastic member exerts an elastic force against said piston;
a rotating member comprising at least two gears, said at least two gears being sequentially and respectively engaged with said at least two transmission portions of said piston when said piston slides in said piston tube; and
a pointer driven by said rotating member to swivel.

2. The pressure gauge as claimed in claim 1, wherein said piston comprises an extension arm that protrudes from one end of said piston and extends in an axial direction; said at least two transmission portions are arranged at intervals or dislocations along said extension arm.

3. The pressure gauge as claimed in claim 1, wherein said at least two transmission portions are formed on an outer circumference of said piston.

4. The pressure gauge as claimed in claim 1, wherein said rotating member comprises a central shaft, on which said at least two gears are coaxially formed with different diameters.

5. The pressure gauge as claimed in claim 1, wherein said rotating member is located adjacent to the piston tube and provided with a top end disposed with said pointer.

6. The pressure gauge as claimed in claim 1, further comprising a dial; said dial comprises at least two pressure indicating areas with divisional scale; said pointer is driven by said rotating member to swivel between the at least two indicating areas.

7. A pressure gauge with divisional scale, comprising:
a piston comprising at least two transmission portions arranged at intervals;
a rotating member comprising at least two gears, said at least two gears being sequentially and respectively engaged with said at least two transmission portions of said piston when said piston slides, such that said rotating member is rotatably driven by said piston; and
a pointer driven by said rotating member to swivel.

8. The pressure gauge as claimed in claim 7, wherein said piston comprises an extension arm that protrudes from one end of said piston and extends in an axial direction; said at least two transmission portions are arranged at intervals along said extension arm.

9. The pressure gauge as claimed in claim 7, wherein said at least two transmission portions are formed on an outer circumference of said piston.

10. The pressure gauge as claimed in claim 7, wherein said rotating member comprises a central shaft, on which said at least two gears are coaxially formed with different diameters.

11. The pressure gauge as claimed in claim 7, wherein said rotating member is located adjacent to said piston and provided with a top end disposed with said pointer.

12. The pressure gauge as claimed in claim 7, further comprising a dial; said dial comprises at least two pressure indicating areas with divisional scale; said pointer is driven by said rotating member to swivel between the at least two pressure indicating areas.

13. A pressure gauge with divisional scale, comprising:
a piston comprising at least two transmission portions;
a rotating member comprising at least two gears with different diameters, said rotating member being rotated by said piston in a way that said at least two gears are sequentially and respectively engaged with said at least two transmission portions of said piston; and
a pointer driven by said rotating member to swivel with at least two different angle amplitudes.
